(19) United States
(12) Patent Application Publication
(10) Pub. No.: US 2019/0280330 A1
(43) Pub. Date: Sep. 12, 2019

(54) ALL-SOLID STATE LI ION BATTERIES COMPRISING MECHANICALLY FELXIBLE CERAMIC ELECTROLYTES AND MANUFACTURING METHODS FOR THE SAME

(71) Applicant: FISKER INC., Los Angeles, CA (US)

(72) Inventor: Fabio ALBANO, Playa Vista, CA (US)

(21) Appl. No.: 16/347,956

(22) PCT Filed: Nov. 8, 2017
(86) PCT No.: PCT/US2017/060546

§ 371 Date: May 7, 2019

(51) Int. Cl. H01M 10/0562; H01M 10/0525; H01M 10/0587; B01J 6/00; C01B 25/00; C01D 15/02; H01M 10/0565; H01M 4/04; H01M 4/131; H01M 4/1391

(52) U.S. Cl. CPC H01M 10/0562; H01M 10/0525; H01M 10/0587; B01J 6/008; C01B 25/003; H01M 2300/0068; H01M 10/0565; H01M 4/0471; H01M 4/131; H01M 4/1391; C01D 15/02

(57) ABSTRACT

An all solid-state Li-ion battery having a mechanically flexible, ceramic, solid-state electrolyte having a lithium-conducting oxide composition selected from the group consisting of perovskite-type oxides, NASICON-structured lithium electrolytes, and garnet-type structures containing transition metal oxides. In particular, the garnet cubic lithiumlanthanium zirconium oxide (c-LLZO), c-LLZO-LSPO composite and various lithium ion conducting sulfides are disclosed.

### RELATED APPLICATIONS

This application claims the benefit of U.S. Provisional Patent Application No. 62/419,423 filed on Nov. 8, 2016, and which is incorporated by reference herein.

### FIELD OF THE INVENTION

The present invention comprehends an all solid-state, Li-ion battery (“LIB”) including a, mechanically flexible ceramic solid-state electrolyte and the manufacturing methods to make it.

### BACKGROUND

The electric vehicle (EV) battery pack performs the same function as the gasoline tank in a conventional vehicle; it stores the energy needed to operate the vehicle. Battery packs usually contain 10-52 individual 6, 8, or 12 volt batteries similar to the starter battery used in gasoline vehicles. Gasoline tanks can store the energy to drive the vehicle 300-500 miles before refilling; however, current generation batteries only offer capacities of 50-200 miles in affordable vehicles and up to a maximum of 335 miles in expensive large luxury vehicles.

Thus, EVs require 30-40 kWh battery packs for a reasonable mileage range and must possess a long cycle life. This imposes practical needs for high energy density and cycle lifetime. United States Advanced Battery Consortium LLC (USABC) targets for EV battery pack performance are listed in Table I, below:

TABLE I
USABC Battery (System Level) Performance Goals for EVs

| | | | Dynamic | |
|---|---|---|---|---|
| | Energy | Power | Stress | |
| | Density | Density | Test Cycle | Cost |
| | (Wh/kg) | (W/kg) | Life | ($/kWh) |
| Current 12 V Pb-A | 35 | 150 | 500 | 150 |
| USABC mid-term goals | 80 | 150 | 600 | 250 |
| USABC long-term goals | 235 | 470 | 1,000 | <100 |

LIBs and Li-metal polymer batteries (LMPBs) are the most advanced commercial energy storage technologies to-date. However, the combined requirements of energy density and power density, cost, and safety for real applications have not been met. Significant improvement towards one of these requirements often compromises the others. Indeed all high-energy density LIBs suffer from infrequent catastrophic failure as well as poor cycle performance. As LIBs increase in energy and power densities, there is a continuing mandate to develop Li+ electrolytes that operate under extremely harsh conditions.

LIBs are the most promising technology for the widespread use of EVs. However, current industry strategies (e.g., high voltage and high capacity active materials) to achieve high gravimetric and volumetric energy densities accelerate degradation mechanisms, capacity loss, capacity fade, power fade, and voltage fade. These are caused by solid-electrolyte interphase (SEI) growth, cathode structure phase changes, gassing, and parasitic side reactions at anodes and cathodes. High capacity anodes such as silicon anodes experience excessive volume changes on cycling, ≈300% compared to 10% for graphite, in addition they suffer from rapid mechanical degradation.

Li metal anodes offer very high energy densities, 3860 mAh/g; however, safety and cyclability remain limitations that must both be addressed for them to be deployed in any practical systems.

### SUMMARY OF THE DISCLOSURE

Disclosed herein is an all solid-state Li-ion battery comprising a mechanically flexible, ceramic, solid-state electrolyte having a lithium-conducting oxide composition selected from the group consisting of perovskite-type oxides, NASICON-structured lithium electrolytes, and garnet-type structures containing transition metal oxides and the manufacturing methods to make them. As is known in the art NASICON generally refers to sodium super ionic conductors. As known to those of skill in the art a perovskite is any material with the same type of crystal structure as calcium titanium oxide (CaTiO₃). They have the general chemical formula of ABX₃, wherein A and B are cations having very different sizes from each other and X is an anion that binds to both A and B.

Per one aspect of the invention, the NASICON-structured lithium electrolytes comprise LiM₂(PO₄)₃, where M=Ti, Zr, or Ge.

Per another aspect, the garnet-type structures containing transition metal oxides comprise Li₅La₃M₂O₁₂, where M=a transition metal.

According to another aspect of the invention, the garnet-type structures containing transition metal oxides comprise amorphous LiPON or LiSi—CON.

Per still another aspect, the garnet-type structures containing transition metal oxides comprise lithium ion-conducting sulfides selected from the group consisting of Li₂S—P₂S₅ glass, Li₂S—P₂S₅—Li₄SiO₄ glass, Li₂S—SiS₂ glass, Li₂S—Ga₂S₃—GeS₂ glass, Li₂S—Sb₂S₃—GeS₂ glass, Li₂S—GeS₂—P₂S₅ glass, Li₁₀GeP₂S₁₂ glass, Li₁₀SnP₂S₁₂ glass, Li₂S—SnS₂—As₂S₅ glass, and Li₂S—SnS₂—As₂S₅ glass-ceramic.

The solid-state electrolyte according to the present disclosure can be formed by one of the methods selected from casting, freeze casting, sublimation, and sintering of slurries that are based on nanoparticles of the ceramic superfast ionic conductor electrolytes described herein and having conductivities (a) comparable to liquid electrolytes at working temperatures, i.e., 10⁻⁶<σ<10⁻¹ S·cm⁻¹, and activation energies that are <0.6 eV.

Nanoparticles that can be used for forming the solid-state electrolytes of the present invention can be fabricated by any of a variety of methods including, without limitation, sol-gel synthesis, plasma spray, ultrasonic assist spray synthesis, fluidized bed reaction, atomic layer deposition (ALD) assisted synthesis, chemical vapor deposition (CVD), physical vapor deposition (PVD), gas phase decomposition, detonation, flame spray pyrolysis, co-precipitation. However, it is preferred to start with nanoparticles having a spherical aspect ratio and bell-shaped size distributions that improve the packing density of the “green” films and result in lower sintering temperatures with final electrolyte film densities above 95%.

Suitable precursor nanoparticle materials for the method of manufacture of the present disclosure include, for instance: super fast ionic conductors with garnet, olivine, perovskite, or NASICON crystal structures, or sulfide or phosphate-based glasses and having enhanced ionic conductivities, e.g. c-LLZO (cubic-lithium lanthanum zirconium oxide) or lithium phosphate.

Suitable solvents for the nanoparticle based slurries can be selected from, but not limited to, water, tert-butyl alcohol (TBA), butanol isomers, poly(vinyl alcohol) (PVA), polyvinyl butyral (PVB) and polyvinyl formal (PVF) or any water-soluble synthetic polymer compatible with the solid-state electrolyte nanoparticles. Preferably the solvent used is water as it is inexpensive, works well, can be rapidly frozen and sublimated via freeze casting to produce films having the desired porosity and density. The solvent is preferably used at a level of from 50 to 70% by weight of the slurry.

In some embodiments the nanoparticle based slurries may optionally include a surfactant or dispersing agent to facilitate the nanoparticle suspension in the solvent. Examples of these surfactants and dispersing agents include, but are not limited to, sodium polynaphthalene sulfonate, sodium polymethacrylate, ammonium polymethacrylate, sodium polyacrylate, sodium lignosulfonate, polyethylene glycol p-(1,1,3,3-tetramethylbutyl)-phenyl ether, and Triton X-100 (C₁₄H₂₂O(C₂H₄O)ₙ).

In one embodiment, the precursor ceramic nanoparticle powder has a composition with a general formula ABO₃ with “A” representing an alkaline or rare earth metal ion and “B” representing a transition metal ion, e.g. Li₃ₓLa_{2/3x}TiO₃ (perovskite).

In another embodiment, the precursor nanoparticle compounds have a general formula of AM₂(PO₄)₃ where “A” represents an alkali metal ion (Li⁺, Na⁺, K⁺) and “M” represents a tetravalent metal ion (Ge⁴⁺, Ti⁴⁺, Zr⁴⁺), e.g. Li_{1.5}Al_{0.5}Ge_{1.5}(PO₄)₃ (NASICON).

In another embodiment, the precursor nanoparticle compounds have a general formula Li₇A₃B₂O₁₂ where “A” represents an eight coordination cation and “B” represents a six coordination cation, e.g. Li₇La₃Zr₂O₁₂ (garnet). Ionic conductivity of these materials could be further enhanced by substitution of “A” cations with Ta, Nb, Al, Ga, In or Te and substitution of “B” cations with Y, Ca, Ba, Sr.

Per one feature, the solid-state electrolyte may be a c-LLZO-Li_{3.4}Si_{0.4}P_{0.6}O₄ (“LSPO”) composite.

Per yet another feature, the solid-state electrolyte may be a metal substituted c-LLZO with a general formula of Li₇La₍₃₋ₓ₎MₓZr₂O₁₂ (garnet), wherein the metal M is selected from the group but not limited to Al, Ga, Ta, W, and elements in group III and IV of the periodic table and wherein “x” has a value of from 0 to 3, thus x can be a whole number or any fraction thereof.

Per yet another feature, the solid-state electrolyte may be a metal substituted c-LLZO with a general formula of Li₇La₃Zr₍₂₋ₓ₎MₓO₁₂ (garnet), wherein the metal M is selected from the group but not limited to Sc, Y, Ti, or another transition metal and x can have any value from 0 to 2. In yet another embodiment, the precursor materials are crystalline or amorphous nanoparticles of solid sulfide-based electrolytes, such as those of the Li₂S—SiS system or those having compositions of the format Li₄₋ₓGe₃ₓ PₓS₄, where x is a number between 0 and 1.

According to another feature, the solid-state electrolyte is formed by casting nanoparticles of precursor materials made via spray pyrolysis of liquid precursors or by another suitable method, into a film followed by sintering the film wherein the sintering takes place at temperatures below approximately 1,100° C.

According to another feature an electrolyte scaffold, meaning a porous electrolyte structure, can be manufactured by freeze-casting nanoparticle based slurries of the precursor materials described herein. In some embodiments the freeze-casting may be followed by a sintering step at temperatures below 1,100° C.

In another embodiment the sintering step is further assisted by optical heating methods, e.g. laser, photonic, or flashing of suitable wavelength light. In another embodiment the sintering step is further assisted by IR irradiation or by an equivalent bulk heating method. Alternatively, the sintering is assisted by electrical or electromagnetic fields, wherein the sintering takes place within seconds of exposure and at temperatures below 1,000° C., preferably at temperatures between 90° C. and 700° C.

In certain embodiments of the present invention the anode, cathode or electrolyte material can be formed into a film and the films can include a thin-film coating buffer layer applied to their surface before or after sintering and interfacing one or all of the individual layers. This facilitates lithium ionic mobility between layers and reduces or prevents layer-to-layer contact resistance, a hindrance that typically plagues solid state lithium batteries. Moreover, such a buffer layer may prevent anode, cathode and electrolyte materials interdiffusion and promote adhesion between layers of dissimilar composition, crystal structure and mechanical properties. Suitable materials for such a buffer layer may be selected from, without limitation, compounds from the group including Li₂O, B₂O₃, WO₃, SiO₂, Li₃PO₄, P₂O₅, Fe₃(PO₄)₂, CO₃(PO₄)₂, Ni₃(PO₄)₂, Mn₃(PO₄)₂ and mixtures thereof.

In yet another embodiment the thin-film coating buffer layer applied to anode, cathode or electrolyte layers consists of a polymeric material or a polymer electrolyte material based on a material selected from the group consisting of polyethylene oxide (PEO), poly(vinyl alcohol) (PVA), aramids, and polyaramid polyparaphenylene terephthalamide.

Any of the solid-state electrolyte precursor nanoparticles or the sintered film, the cathode precursor nanoparticles or the sintered film, and the anode precursor nanoparticles or the sintered film may be infiltrated or pre-coated with, respectively, an intermediate phase between the electrolyte and a secondary or tertiary compound, a catholyte, or an anolyte selected from, without limitation, the group consisting of Li, Li₂O, B₂O₃, WO₃, SiO₂, Li₃PO₄, P₂O₅, Fe₃(PO₄)₂, CO₃(PO₄)₂, Ni₃(PO₄)₂, Mn₃(PO₄)₂, lithium phosphorous oxy-nitride (“LiPON”) and LaTiO₃.

In yet another embodiment the catholyte, the anolyte or both are essentially made from a solid state electrolyte. The solid state electrolyte precursor particles can be mixed with the cathode or anode active materials particles to create a composite. Alternatively the catholyte and anolyte materials could be incorporated in the cathode and anode slurries as powders during the mixing operation and before casting or they could be infiltrated into the porous electrode structure after the anode and cathode electrodes are formed.

Per a still further feature, the solid-state electrolyte includes a lithium phosphorous oxy-nitride (“LiPON”) coating applied to the surface of the films either pre-sintering or, alternatively, after sintering and before calandering.

In yet another embodiment the electrolyte film prepared according to the present disclosure includes a polymer coating applied after sintering and before anode or cathode layers are bonded to the electrolyte or the electrolyte scaffold.

According to yet a further feature, Li is melt-infiltrated into the solid-state electrolyte prepared according to the present disclosure. Further embodiments comprise a composite electrolyte film with lithium infiltrated between the composite grains or as an intermediate electrolyte phase acting as an anolyte or a catholyte infiltrated in between the composite grains or the active material grains, e.g. in the cathode. Such an intermediate electrolyte phase comprises at least two components resulting from the reaction of the lithium or the cathode materials with the electrolyte forming a binary or tertiary intermediate phase.

In yet another embodiment a lithium or lithium alloy ribbon, foil or other suitable metallic film form is laminated onto the electrolyte layer to form the anode. Between the electrolyte and the metallic lithium anode there may be an intermediate layer interposed made of, but not limited to, compounds from the group including Li₂O, B₂O₃, WO₃, SiO₂, Li₃PO₄, P₂O₅, Fe₃(PO₄)₂, Co₃(PO₄)₂, Ni₃(PO₄)₂, Mn₃(PO₄)₂ and mixtures thereof.

In yet another embodiment the thin-film intermediate layer consists of a polymeric material or a polymer electrolyte material based on a material selected from the group consisting of PEO, PVA, aramids, and polyaramid polyparaphenylene terephthalamide.

### BRIEF DESCRIPTION OF THE DRAWINGS

An embodiment will now be described, by way of example only, with reference to the accompanying drawings, wherein:

FIG. 1 is a graphic providing a comparison of various properties and features of c-LLZO as employed in the present invention, versus common ionic conductors including LiPON and Li₁₀GeP₂S₁₂ (“LGPS”);

FIG. 2A shows a graph demonstrating the high ionic conductivity of two doped solid-state electrolyte samples prepared by casting and sintering at 1000° C. an c-LLZO nanoparticle slurry, according to the present disclosure, having a D50 average nanoparticle size of 400 nanometers (nm);

FIG. 2B shows a charge-discharge curve of a solid state battery cell according to the present disclosure by infiltrating a nickel-manganese-cobalt (NMC) cathode material into an LLZO electrolyte scaffold and laminating a lithium metal anode onto it, the results demonstrate the high energy density potential of the system exceeding 170 mAh/g;

FIG. 3 is a Ragone plot of the performance of the current technology according to the present disclosure compared to existing and emerging battery technologies;

FIG. 4A is a chart showing methods for casting nanoparticle slurries into films according to the present disclosure;

FIG. 4B is a flow chart showing the basic steps in the manufacturing of a solid-state electrolyte film according to the present disclosure;

FIG. 4C is a diagram showing the further assisting of the sintering process using light as described herein;

FIG. 4D is a diagram showing the basic steps in converting a nanoparticle slurry to a free standing sintered film using freeze-casting to form the film according to the present disclosure freeze-casting of electrodes and Li-conducting solid-state electrolytes;

FIGS. 5A through 5C depict in various views the constituents of exemplary battery architectures according to the present disclosure incorporating a bipolar electrode arrangement with a common substrate;

FIG. 6 shows one exemplary cylindrical cell monoblock and an enlarged view of the stack prepared using the solid-state electrolytes according to the present disclosure and having a 14.8 Volt capacity;

FIG. 7 is a schematic representation of several viable routes according to the present disclosure that lead to the creation of a smooth electrode/electrolyte interface that reduces or eliminates contact resistance and promotes ionic conductivity;

FIG. 8A shows the reduction of system complexity and layers by means of solid-state electrolyte and implementation of a solid catholyte or anolyte materials approach according to the present disclosure compared to a traditional Li-ion battery;

FIG. 8B shows a schematic of the microstructure of a freeze-cast composite cathode prepared according to the present disclosure);

FIG. 9 shows problems addressed by the novel solid-state battery architecture according to the present disclosure and the effects/advantages resulting to the system;

FIG. 10A is a schematic depiction of a LiPON-coated LLZO electrolyte in a symmetrical cell configuration according to the present disclosure;

FIG. 10B is a schematic depiction of the dendrite suppression benefit of a Li-ion battery prepared according to the present disclosure enabling the use of lithium metal anodes;

FIG. 11 is a schematic depiction of a Li/electrolyte composite symmetrical cell according to the present disclosure, with the arrows indicating the Li current in the cell; and

FIG. 12 is a schematic depiction of a full-cell with composite cathode and anodes prepared according to the present disclosure.

### DETAILED DESCRIPTION OF A PREFERRED EMBODIMENT

Disclosed herein is an all solid-state, mechanically flexible Li-ion battery (LIB) having a ceramic, mechanically flexible solid-state electrolyte formed by freeze-casting or casting, preferably in combination with sintering, of nanoparticle slurries of ceramic, superfast ionic conductors prepared according to the present disclosure. The nanoparticle slurries are formed into thin films by casting, preferably followed by sintering at temperatures below 1,100° C. and then further formed into structures within a LIB. They preferably have conductivities comparable to liquid electrolytes at working temperatures, i.e., 10⁻⁶<σ<10⁻¹ S·c⁻¹, and activation energies that are <0.6 eV.

Disclosed herein is an all-solid-state, mechanically flexible LIB including ceramic solid-state electrolytes comprising a lithium-conducting oxide composition selected from the group consisting of perovskite-type oxides, NASICON-structured lithium electrolytes, and garnet-type structures containing transition metal oxides.

In one form, the solid-state electrolyte is cubic-Li₇La₃Zr₂O₁₂ (“c-LLZO”). Per one feature, the solid-state electrolyte may be a c-LLZO-Li_{3.4}Si_{0.4}P_{0.6}O₄ (“LSPO”) composite.

Per yet another form, the solid-state electrolyte may be a metal substituted c-LLZO with a general formula of Li₇La₍₃₋ₓ₎MₓZr₂O₁₂ (garnet), wherein the metal M is selected from the group but not limited to Al, Ga, Ta, W, and elements in group III and IV of the periodic table and wherein x has a value of from 0 to 3.

Per yet another form, the solid-state electrolyte may be a metal substituted c-LLZO with a general formula of Li₇La₃Zr₍₂₋ₓ₎MₓO₁₂ (garnet), wherein the metal M is selected from the group but not limited to Sc, Y, Ti, and another transition metal and wherein x has a value of from 0 to 2.

In one form, the battery designed according to the present disclosure may be a 12V (nominal voltage) LIB made with such mechanically flexible solid-state electrolytes, wherein the solid-state electrolytes are made using scalable casting and sintering methods based on metal-oxide nanoparticle powders. More specifically, the solid-state electrolyte membranes (e.g. <30 um thick) may be fabricated using nanoparticle powders that have sizes ranging from 20-900 nanometers synthesized by flame-spray pyrolysis, co-precipitation or other solid-state or wet chemistry nanoparticle (“NPs”) fabrication routes.

Nanoparticles that can be used for the invention can be synthesized by any of a variety of methods including, without limitation, plasma spray, ultrasonic assist spray synthesis, fluidized bed reaction, atomic layer deposition (ALD) assisted synthesis, direct laser writing (DLW), chemical vapor deposition (CVD), low pressure chemical vapor deposition (LPCVD), microwave plasma enhanced chemical vapor deposition (NPECVD), pulsed laser deposition (PLD), physical vapor deposition (PVD), gas phase decomposition, detonation, flame spray pyrolysis, co-precipitation, sol-gel synthesis, sol-gel dipping, spinning or sintering. As described they preferably have an average particle size of from 20 to 900 nm, more preferably from 200 to 600 nm.

The nanoparticles that can be used for preparing the solid-state electrolytes according to the present disclosure in certain embodiments can be coated, treated at the surface or throughout the bulk or in any open porosity by one or multiple layers of solid electrolyte materials or intermediate phases between solid electrolyte and anode or cathode active materials, e.g. a catholyte or anolyte suitable compound using one or more sequential deposition processes selected from, without limitation, plasma treatment, ultrasonic assist spray, fluidized bed reaction, atomic layer deposition (ALD), direct laser writing (DLW), chemical vapor deposition (CVD), low pressure chemical vapor deposition (LPCVD), microwave plasma enhanced chemical vapor deposition (NPECVD), pulsed laser deposition (PLD), physical vapor deposition (PVD), gas phase decomposition, detonation, flame spray pyrolysis, co-precipitation, sol-gel synthesis, sol-gel dipping, spinning or sintering, sputtering, radio frequency magnetron sputtering, nanoimprint, ion implantation, laser ablation, spray deposition.

It is preferred, but not strictly necessary, to start with nanoparticles having a spherical aspect ratio and bell-shaped size distributions that improve the packing density of the green films formed and result in lower sintering temperatures with final film densities above 95% for incorporation into a LIB design.

Suitable precursor nanoparticle materials include, for instance, ionic conductors with garnet, olivine, perovskite, or NASICON crystal structures, or sulfide or phosphate based glasses and having enhanced ionic conductivities, e.g. c-LLZO or lithium phosphate as described herein.

In one embodiment, the precursor ceramic nanoparticle powder has a composition with a general formula ABO₃ with “A” representing an alkaline or rare earth metal ion and “B” representing a transition metal ion, e.g. Li₃ₓLa_{2/3x}TiO₃ with a perovskite type oxide structure.

In another embodiment, the precursor compounds have a general formula of AM₂(PO₄)₃ where “A” represents an alkali metal ion (Li⁺, Na⁺, K⁺) and “M” represents a tetravalent metal ion (Ge⁴⁺, Ti⁴⁺, Zr⁴⁺), e.g. Li_{1.5}Al_{0.5}Ge_{1.5}(PO₄)₃ (NASICON structured lithium electrolyte).

In another embodiment, the precursor compounds have a general formula Li₇A₃B₂O₁₂ where “A” represents an eight coordination cation and “B” represents a six coordination cation, e.g. Li₇La₃Zr₂O₁₂, a garnet type structure including a transition metal oxide. Ionic conductivity of these materials could be further enhanced by substitution of “A” cations with Ta, Nb, Al, Ga, In or Te and substitution of “B” cations with Y, Ca, Ba, Sr.

In yet another embodiment, the precursor materials are crystalline or amorphous nanoparticles of solid sulfide-based electrolytes, such as those of the Li₂S—SiS system or those having compositions of the format Li₄₋ₓGe₁ₓPₓS₄, where x has a value between 0 and 1.

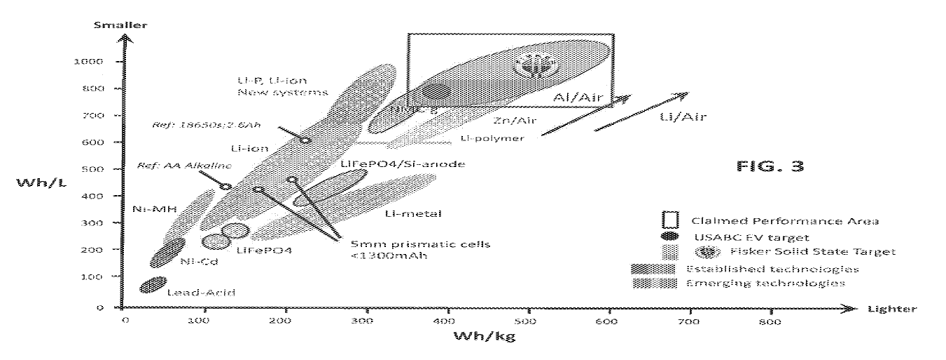

The batteries produced using the approaches disclosed in the present invention will have superior performance to any of the existing lithium ion or other battery chemistries. Additionally, they will have distinct performance from any of the emerging battery technologies as outlined in FIG. 3. In particular the batteries produced with the methods disclosed herein will have gravimetric energy density between 350 and 650 Wh/kg and will also have volumetric energy density between 750 and 1,200 Wh/L.

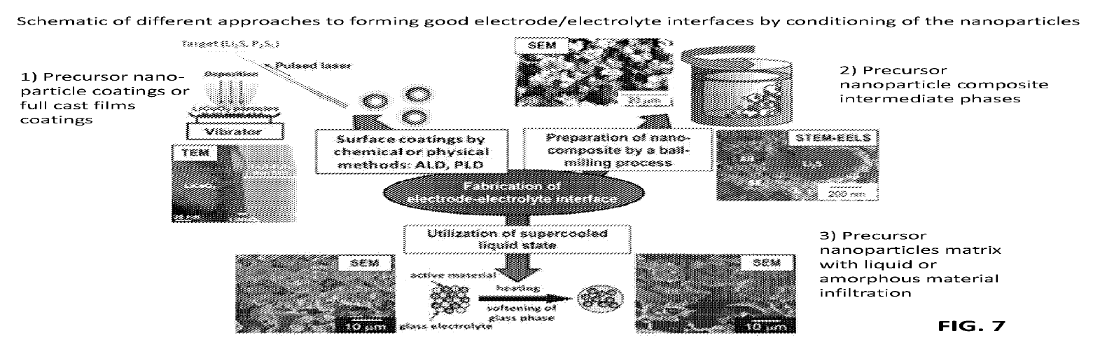

The nanoparticles used to form the slurries in the present disclosure may be conditioned using one of the three approaches shown in FIG. 7. For example, the nanoparticles may be coated using atomic layer deposition (ALD) or pulsed laser deposition (PLD) in a fluidized bed reactor to create a good electrode-electrolyte interface. One of the suitable material coatings applied via ALD or PLD may be lithium-phosphorous-oxynitride (LiPON) or another suitable solid-state electrolyte coating. In another embodiment, the nanoparticles may be made into nano-composite particles by ball-milling as shown in FIG. 7. This process allows creating intermediate phases between the active materials and the electrolyte that are useful as catholyte or anolyte, and facilitates ionic diffusion within the anode or cathode films and that support subsequent manufacturing steps, e.g. the creation of a functional interface layer at the anode or cathode interfaces with the electrolyte films. Such interfaces are needed in particular to manage dendrites and lithium metal shorting generating from a lithium metal anode in contact with certain solid-state electrolytes, e.g. LLZO. Also as shown in FIG. 7 the nanoparticles can be conditioned by forming a matrix with liquid or amorphous material infiltration using for example various glass electrolytes.

According to another feature, the solid-state electrolyte is formed by casting into a film and then sintering of nanoparticles of precursor materials made via spray pyrolysis of liquid precursors, or another suitable method, wherein the sintering takes place at temperatures below approximately 1,100° C.

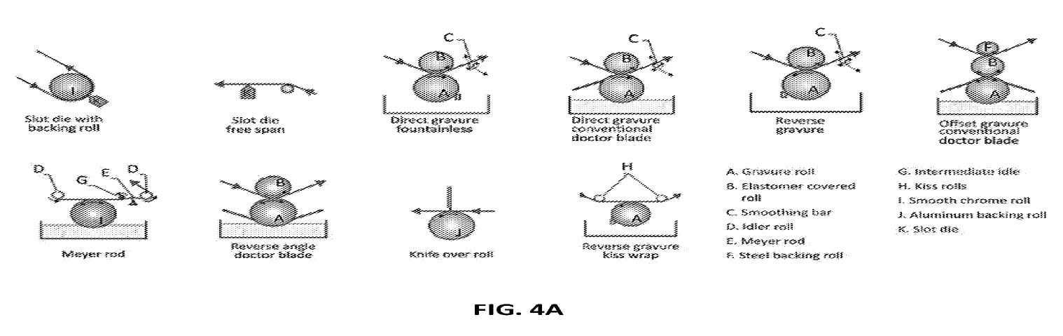

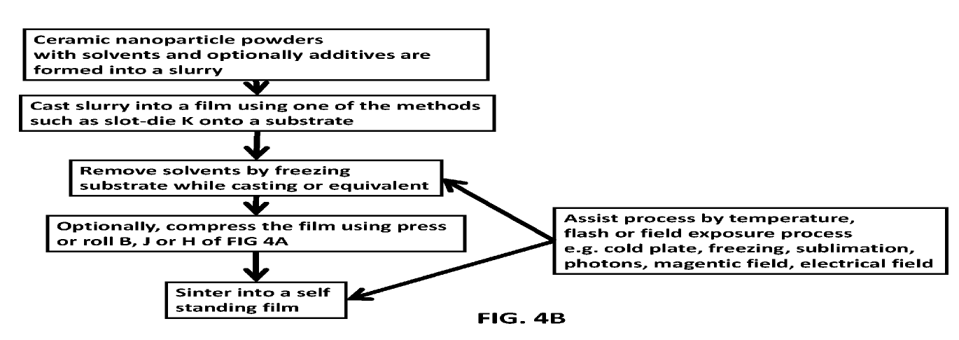

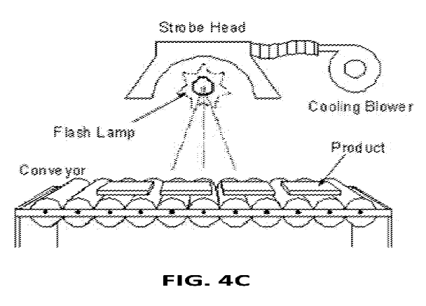

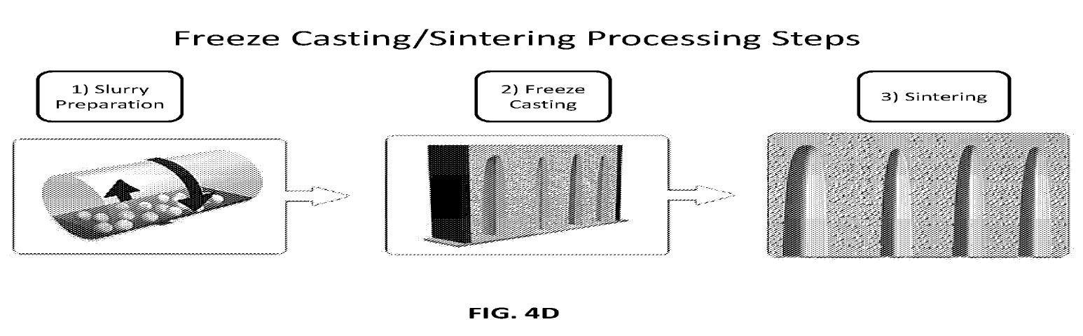

The basic process steps in the present disclosure are shown in FIG. 4B as further described in FIGS. 4A, 4C and 4D. In a first step the nanoparticle precursor materials are formed into a slurry using a suitable solvent and optional additives. Suitable solvents for the nanoparticle based slurries can be selected from, but not limited to, water, tert-butyl alcohol (TBA), butanol isomers, poly(vinyl alcohol) (PVA), polyvinyl butyral (PVB) and polyvinyl formal (PVF) or any water-soluble synthetic polymer compatible with the solid-state electrolyte nanoparticles. Preferably the solvent used is water as it is inexpensive, works well, can be rapidly frozen and sublimated via freeze casting to produce films having the desired porosity and density. The solvent is preferably used at a level of from 50 to 70% by weight of the slurry.

In some embodiments the nanoparticle based slurries may optionally include a surfactant or dispersing agent to facilitate the nanoparticle suspension in the solvent. Examples of these surfactants and dispersing agents include, but are not limited to, sodium polynaphthalene sulfonate, sodium polymethacrylate, ammonium polymethacrylate, sodium polyacrylate, sodium lignosulfonate, polyethylene glycol p-(1,1,3,3-tetramethylbutyl)-phenyl ether, and Triton X-100 (C₁₄H₂₂O(C₂H₄O)ₙ).

The slurries are then cast into a film using one of the processes shown in FIG. 4A, preferably via freeze casting using a slot die K with sublimation of the solvent. In freeze casting the casting bed is at a temperature at or below the freezing point of the solvent and the cast slurry freezes within 15 seconds or less with sublimation of the solvent. This preferably produces an electrolyte scaffolding film having a porosity of greater than 50%, fairly uniform pore sizes of 5 micron or larger wherein the pores are oriented in the same direction. Preferably this freeze casting is followed by sintering steps conducted under an extra dry atmosphere comprising air, O₂ or N gases. Air is preferred due to cost considerations. The initial sintering takes place at a lower temperature of 500 to 700° C. for 1 to 4 hours. This is followed by sintering at higher temperatures of 1,100° C. or less for 1 to 8 hours with the temperature increased using a temperature ramp rate of 5 to 10° C. per minute under very low to no pressure. The electrolyte solid-state scaffolding can then be infiltrated with cathode or anode active material having a particle size of less than the pore size, preferably the selected active materials have a D50 particle size of from 5 to 10 microns, which is typical for commercial anode and cathode active materials. The cathode or anode active material is formed into a slurry and infiltrated into the materials. Alternatively the film is formed as a dense solid-state electrolyte with no porosity and a density of greater than 95%. The infiltrated electrolyte can be used to form anodes or cathodes as described and shown herein. In one embodiment the layers comprise from one side to another of the stack: a cathode formed by infiltrating a porous solid-state electrolyte with a cathode active material; next a solid-state electrolyte layer having a density of greater than 95% and finally an anode formed by infiltrating a porous solid-state electrolyte with an anode active material. Preferably the porosity of the electrolyte scaffold permits a loading of the cathode or anode material to a level of greater than 10 mAh/cm², more preferably 40 mAh/cm², which would provide greater than 500 Wh/Kg.

In another embodiment the sintering is assisted by optical heating methods, e.g. laser, photonic, or flashing of suitable wavelength light. Alternatively, the sintering is assisted by electrical or electromagnetic fields, wherein the sintering takes place within seconds of exposure and at temperatures below 1,100° C., preferably at temperatures between 90° C. and 700° C., see for example FIGS. 4B and 4C.

The anode, cathode or electrolyte films may include a thin-film coating buffer layer applied to their surface before or after sintering and interfacing one or all of the individual layers. This facilitates Lithium ionic mobility between layers and reduces or prevents layer-to-layer contact resistance, a hindrance that typically plagues solid-state lithium batteries. Moreover, such a buffer layer may prevent anode, cathode and electrolyte materials interdiffusion and promote adhesion between layers of dissimilar composition, crystal structure and mechanical properties. Suitable materials for such a buffer layer may be selected from, without limitation, compounds from the group including Li₂O, B₂O₃, WO₃, SiO₂, Li₃PO₄, P₂O₅, Fe₃(PO₄)₂, Co₃(PO₄)₂, Ni₃(PO₄)₂, Mn₃(PO₄)₂, and mixtures thereof.

Per a still further feature, the solid-state electrolyte includes a lithium phosphorous oxy-nitride (“LiPON”) coating applied to the surface of the films pre-sintering or, alternatively, after sintering and before calandering.

In yet another embodiment, active material nanoparticles are mixed with a glass or glass ceramic solid state electrolyte, e.g. a lithium ion-conducting sulfide with Li₃PS₄ (LPS), and the precursor nanoparticles are infiltrated and coated by means of heating above the glass transition temperature of the glass electrolyte, bringing the solid electrolyte to a super cooled liquid state as shown in FIG. 7.

The inventive LIBs disclosed herein are made economical via manufacture using a low pressure sintering method and the replacement of existing separator materials, liquid electrolytes, and temperature management peripherals. In FIG. 4A to FIG. 4D, the manufacturing steps that enable novel routes of synthesizing these layered materials in an industrial process with high throughput are shown. Once the nanoparticle slurry is made, any of the application methods can be used shown in FIG. 4A to 4D, e.g. freeze-casting reported in FIG. 4D, to form films of the slurries and then the individual formed film layers can be sintered through a low pressure process at temperatures below 1,100° C. Alternatively, multiple layers can be sintered in one single pass through the sintering process after laying down multiple films. As shown in FIGS. 4A and 4B a variety of methods can be used to form the films from the nanoparticle slurries that are then sintered. Results with films prepared according to the present disclosure have shown in Scanning Electron Microscopy (SEM) images that the produced films have low surface asperity and are preferably very smooth, hence, as shown in FIG. 4B an optional step can include a compression step to further remove any surface roughness and to reduce it to an average surface roughness parameter of less than 400 nm. In certain embodiments the sintering may be assisted with optical methods, e.g. a flash lamp or a laser; the sintering assist method increases the manufacturing throughput and facilitates the sintering process so it can take place at lower than theoretical temperatures, see FIG. 4C.

In another embodiment of the present invention the individual layers or the whole stack can be formed via casting, freeze-casting or any other viable method that is capable of forming a thick film of the precursor nanoparticle material. After the casting and the solvent removal by drying or sublimation, the film may undergo a sintering step as shown.

The present invention also comprehends several avenues to improve c-LLZO films to enable Li cycling without shorting, to generate solid ion conductors that can prevent dendrite growth, self-discharge, and to promote safety, power and cycle life.

A major challenge for wide deployment of c-LLZO is processing feasibility at thicknesses similar to existing ion conducting membranes (ICMs) and polyolefin separators, i.e. 20-30 μm, such that the substitution of liquid with solid-state electrolyte comes with no performance loss. While numerous reports are available regarding the fundamental properties of c-LLZO based on pellet forms, the accumulated knowledge has not been translated to solid-state continuous films due to energy/equipment-intensive sintering of c-LLZO. Prolonged sintering times of 10-40 hours and lithium loss at temperatures >1000° C. greatly impede obtaining single-phase c-LLZO solid-state films with properties matching pellet counterparts due to higher surface/volume ratios, thereby accelerating Li loss during heating. Only hot-pressing has been successful in reducing the sintering duration but requires specialized and costly equipment, hindering mass-production at commercial scales. Also, thin film formability by hot-pressing has yet to be demonstrated.

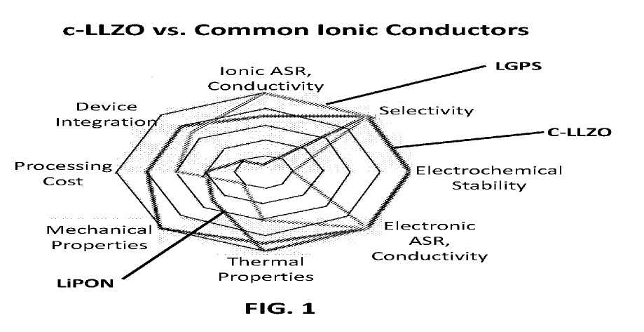

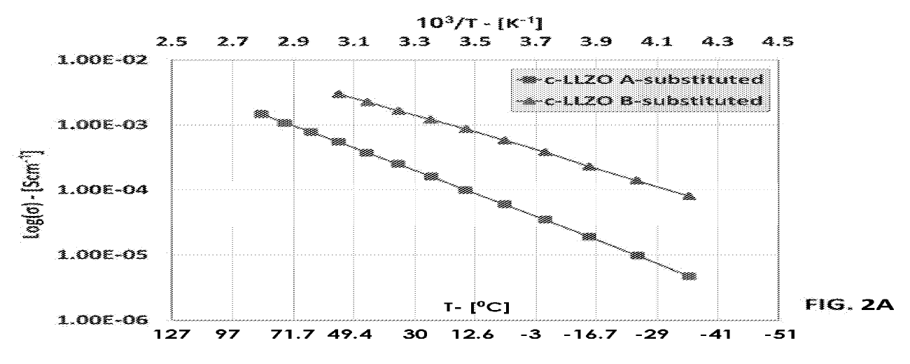

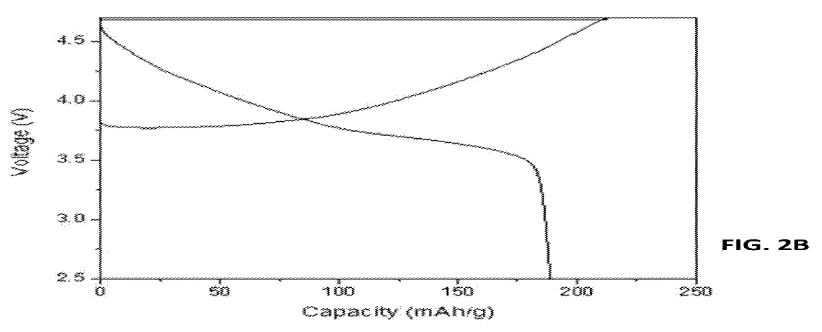

Solid-state ion conductors, e.g. newly developed mechanically flexible c-LLZO combined with high energy density cathodes and Li anodes according to the present disclosure represent innovations that remove the tradeoffs between energy and cycle life. Novel, mechanically flexible c-Li₇La₃Zr₂O₁₂ ion-conducting solid-state films made by freeze-casting and low-pressure-sintering of nanoparticles according to the present disclosure can overcome most of the existing technical gaps in solid-state electrolytes and can attain ionic conductivities comparable to liquid electrolytes see FIGS. 1 and 2A. As shown in FIG. 2A freeze cast films sintered according to the present invention show significant conductivity even at temperatures below 0° C. and even below −30° C. The A-substituted film was formed from Li₇La₃₋ₓMₓZr₂O₁₂ wherein M was aluminum; the B-substituted film was formed using gallium as the metal. These materials prepared according to the present disclosure are uniform, thin ≤30 μm, mechanically flexible, 95+% dense with Li+ conductivity comparable to traditional ICMs with liquid electrolytes. The slope of the curves is constant and linear, prior art systems demonstrate a hockey stick shaped curve wherein the conductivity at temperatures of 0° C. or lower are equal to nearly 0. In addition other solid-state electrolyte materials, well-known in the field of thin-film batteries, are costly, produced through unscalable techniques and difficult to integrate in existing battery systems due to the lack of mechanical flexibility. FIG. 2B demonstrates the benefits of solid-state ionic conductors according to the present disclosure like the ones reported in FIG. 2A when integrated into a full solid-state battery cell system constructed using freeze casting methods outlined in the present invention. The cell was constructed by infiltrating a nickel-manganese-cobalt (NMC) cathode material into an LLZO scaffold and laminating a lithium metal anode onto it. The curve shows high initial and midpoint voltages that represent low internal resistance and high energy density of greater than 170 mAh/g.

Previously it has been demonstrated that c-LLZO and LiTi₂(PO₄)₃ Li+ conducting films by processing NPs can provide films <30 μm thick with ion conductivities ˜1 mS cm⁻¹. Details are described, for instance, in Eongyu Yi et al., “Flame made nanoparticles permit processing of dense, flexible, Li+ conducting ceramic electrolyte thin films of cubic-Li₇La₃Zr₂O₁₂ (c-LLZO),” J. Mater. Chem. A, 2016, 4, 12947-12954. These prior art films suffers from several deficiencies including: they have very little to no conductivity at temperatures of 0° C. or less; they require high sintering temperatures well above 1,110° C. and very long sintering times. All of these drawbacks make these films impractical for use in commercial batteries.

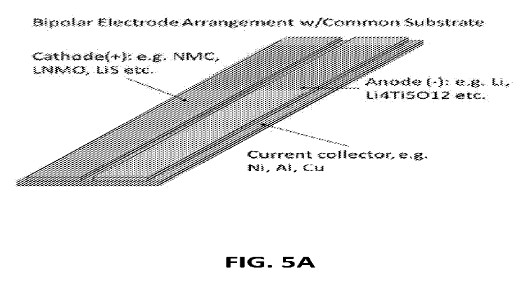

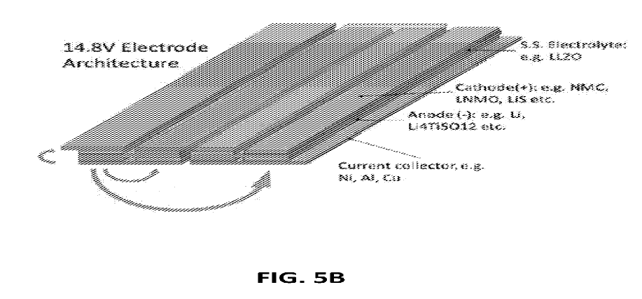

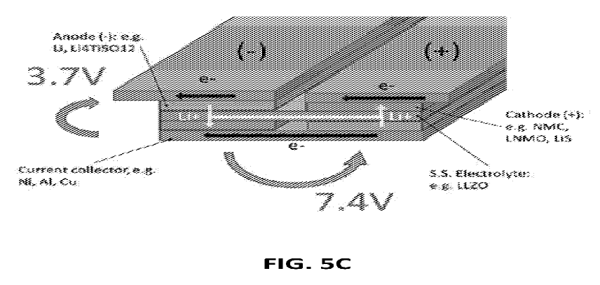

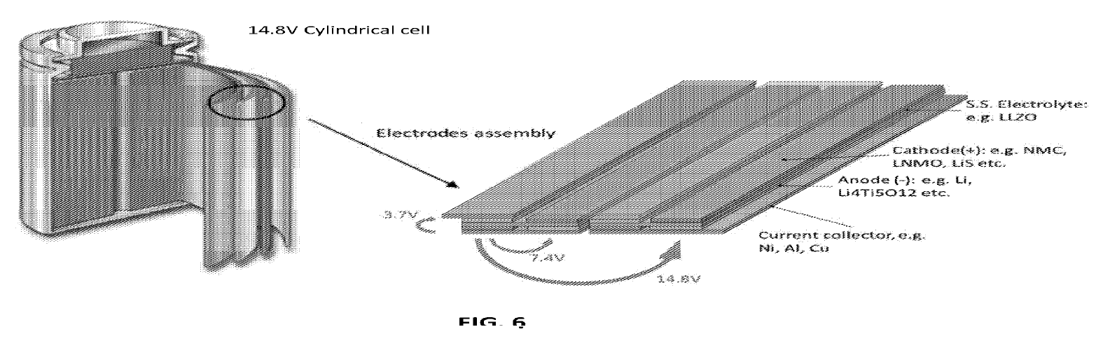

FIG. 4A-4D show the processing steps needed to produce films according to the present disclosure. The use of nanoparticles within the desired size range described herein permits one to create dense solid-state films and to use low sintering temperatures of less than 1,100° C. and much shorter sintering times to produce the final films. The solid state and mechanically flexible nature of the electrolyte films of the present invention lend themselves to more complex electrode architectures such as those shown in FIGS. 5A through 5C and FIG. 6. A first benefit provided by the LLZO films according to the present disclosure is the elimination of leakage/shunt current pathways when multiple cells are connected in series in a semi-bipolar configuration per FIGS. 5A through 5C. Secondly these mechanically flexible films mitigate mechanical stresses that may originate during charge/discharge due to volume changes and to vibration in vehicular applications, e.g. stop/start systems, hybrid electric vehicles (HEVs) or EVs. Finally, the direct electron path between negative and positive electrodes and the lack of outer cell-to-cell connections enables for designing systems with extremely high power in spite of the solid-state nature of the electrolyte system FIGS. 5A through 5C. FIG. 6 shows one exemplary cylindrical cell monoblock and an enlarged view of the stack prepared using the solid-state electrolytes according to the present disclosure and having a 14.8 Volt capacity. The cathode can be formed from a nickel-manganese-cobalt (NMC) compound, LNMO, LiS and other known materials. The solid-state electrolyte such as a c-LLZO is shown located between the cathode and the anode. The anode is adjacent the current collector in the stack as shown. The stack is jelly rolled to form the cylindrical cell as shown.

It has already been demonstrated in the literature how to produce thin LLZO films of <30 μm thick and a few cm² in size. While this is a notable achievement, translating to thinner films of <15 μm with larger area dimensions of >30 cm² raises more processing challenges. The present disclosure process has overcome these processing challenges by: utilizing precursor particles having a nanometer size with D50 particle size of 20 to 900 nm, more preferably 200 to 600 nm and most preferably approximately 400 nm while the prior art utilized particles having a size of greater than 1 micron; by assisting the casting process steps with other techniques including freeze-casting and sublimation of the slurry solvents; and by controlling electrode and electrolyte microstructure and porosity by using proper casting temperature and times/speed. As described herein preferably in one embodiment the porosity is greater than 50%, with uniform pores having a size of 5 microns or larger and uniform direction of the pores. The sensitivity of LLZO sintering to numerous parameters is notable and raises concerns in obtaining large area films with uniform microstructures and phase compositions. Even >90% uniformity may actually be insufficient. Open pores, generated by partial over- or under-exposure during sintering will likely be avenues for Li dendrite propagation. Thus, temperature variations within the furnace require control of all processing conditions. Alternately, any defective areas, e.g. open pores, may be safely protected/blocked with a very thin solid state amorphous electrolyte, e.g. LiPON, or polymer based solid-state electrolyte overcoat as described herein.

In another embodiment the LLZO film can be cast on a flat bed and the solvent removed via freezing through a sublimation process then followed by a sintering step as shown in FIG. 4D according to the present disclosure.

The present invention lowers sintering temperatures to ≈1000° C. to expand the optimal processing window resulting in higher tolerance to temperature variations during sintering. Compounds in the Li₂O—P₂O₅—SiO₂—B₂O₃(“LPSB”) system have been used widely as sintering aids for LLZO, showing moderate improvements in reducing the required energy input for densification when mixed with micron sized particles. For example, others have sintered Ta:LLZO-Li₃BO₃ (10 vol. %) composites to 90% density at 790° C. with ambient ionic conductivity of 0.36 mS cm⁻¹. Still others have processed Al:LLZO-Li₃BO₃ (13 vol. %) composites to 92% density by sintering at 900° C. with conductivities of 0.1 mS cm⁻¹ at 30° C. The drop in net ionic conductivity is not significant compared to neat LLZO, considering ˜10 vol. % addition of low ionic conductivity secondary phase and low relative densities. However, Li₃BO's low Tm of 700° C. prevents sintering composites at higher temperatures due to volatility, limiting accessible densities. According to our disclosed process the sintering temperatures are lower than in the past which reduces costs and the sintering times are much shorter. In addition, films produced according to the present disclosure are very dense, on the order of greater than 95%, this makes the films much stronger. Unlike the prior art the dense films according to the present disclosure do not require pressure to produce the dense films. Also as shown in FIG. 2A batteries produced according to the present disclosure have reasonable conductivity values even at −30° C. whereas the prior art had little to no conductivity at temperatures of 0° C. or less.

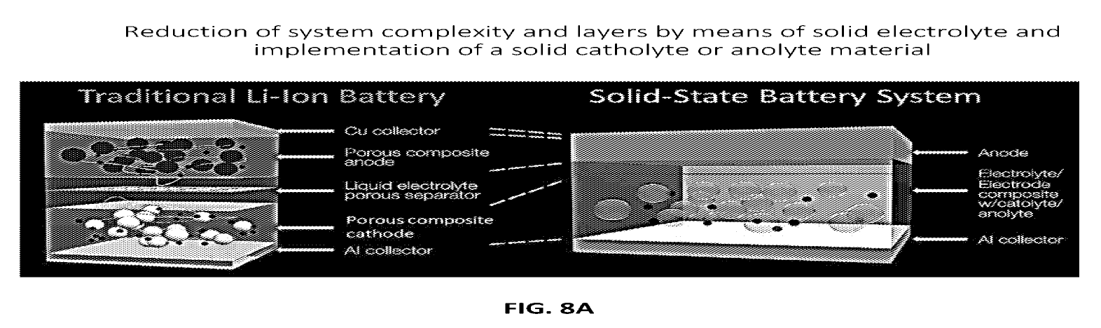

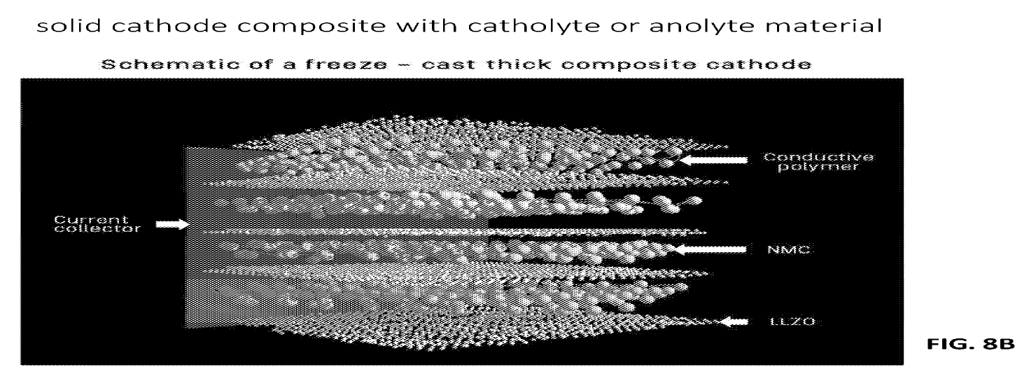

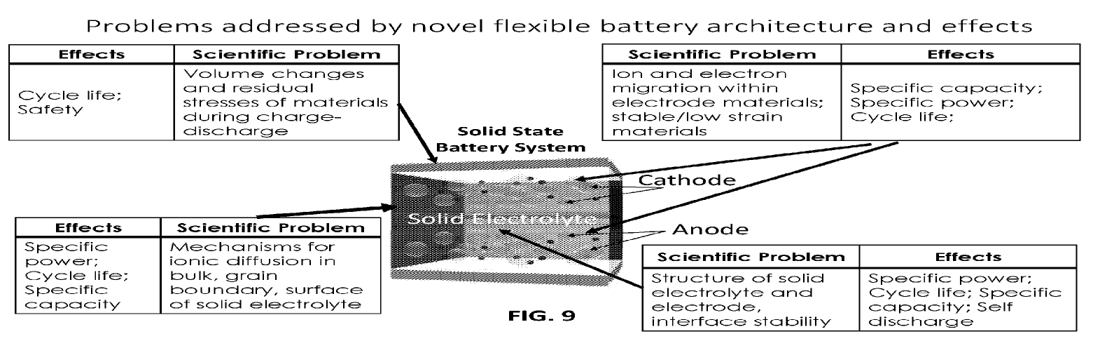

The present invention, in one embodiment, employs LLZO-LPSO composites to reduce sintering temperatures, targeting thin films >95% dense. LSPO has higher conductivity, 4.3×10⁻³ S cm⁻¹ and a Tm of ˜1070° C. compared to Li₃BO₃, so higher net conductivities and densities can be achieved by sintering at >900° C. FIGS. 8A-8B and FIG. 9 show the benefits of using the solid-state mechanically flexible electrolyte in reduction of system complexity and the benefits of improved electrode/electrolyte interfaces.

The film processing disclosed herein can theoretically result in non-uniform microstructural and phase compositional distributions, deteriorating overall performance. Hence, the present invention comprehends introducing solvents, described herein, that can be easily removed via freezing (sublimation) after or during the films coating operation and use of sintering aids to lower the sintering temperatures, widening the optimal sintering window to increase overall uniformity of sintered large area films FIG. 9 thereby avoiding these theoretical issues.

The present invention comprehends fabricating electrolyte/anode composite layers as an alternative approach to increase interfacial areas in order to reduce the interfacial resistance on the cathode side.

Many different (electro)chemical approaches have been proposed to prevent dendrite formation. One suppression method involved adding saccharin or bubbling hydrogen to reduce formation of Ni or Zn dendrites. Magnetic fields have been used to manipulate dendrites morphology during electrodeposition of Cu, suppressing it to some degree. Such measures cannot work for commercial batteries. Other methods include additives to liquids, or gel electrolytes as possible routes to improve LIB stability/performance. Different solid electrolytes have been investigated in production, but these present problems of their own eventually translating to alternative safety concerns and energy losses. Surface microstructural control and surface flattening have been shown to promote a homogeneous distribution of Li current as well as Li/LLZO contact, such that non-uniform dissolution/deposition of Li, i.e. dendrites, and interfacial resistance are reduced, resulting in higher critical current densities.

The present invention comprehends several avenues to either mechanically block Li dendrites or maximize distribution of the Li+ current by increasing Li/electrolyte interfacial areas to enhance tolerable current densities with a target performance >3 mA/cm² at ambient temperature.

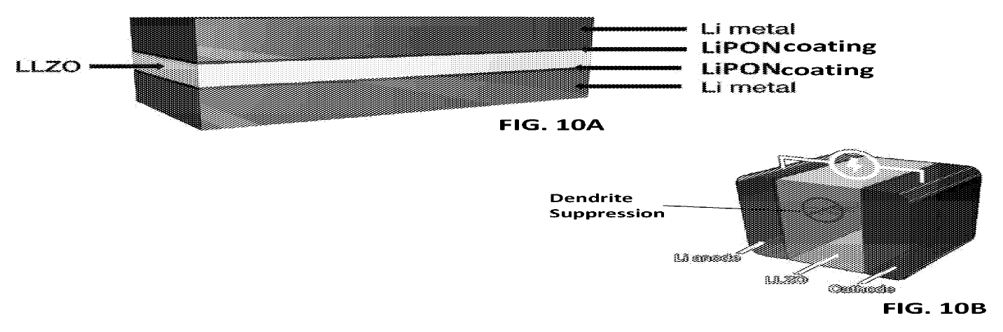

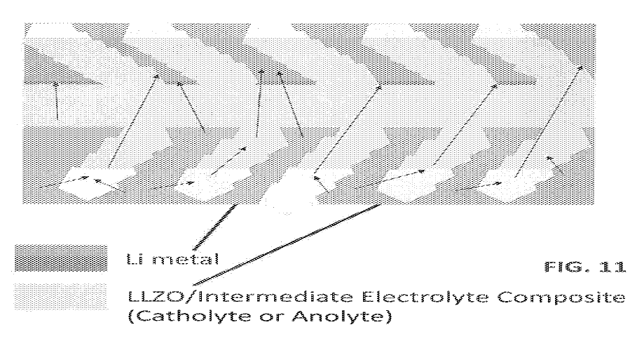

To mechanically and thermodynamically block Li metal dendrites from growing and penetrating through the mechanically flexible electrolyte layer, we disclose a novel route to coat a thin-film layer of solid-state electrolyte, e.g. LiPON, or PEO based electrolyte via coating with polymer precursors allowing facile coating of a thin-film having a thickness of <400 nm on pre-sintered c-LLZO membranes see FIG. 10A. LiPON is well studied in film batteries having thick layers with a total thicknesses≈several μm composed of LiCoO₂/LiPON/Li which successfully demonstrated long cycle life (>10,000 cycles) with no Li dendrite issues at high current densities (>4 mA/cm²). The present disclosure achieves long life cycles and no Li dendrites with much thinner, <400 nm, layers to form very flexible films.

According to yet a further feature, Li metal can be melt-infiltrated into the solid-state electrolyte scaffold to form a solid anode structure. To promote Li current distribution, a Li/electrolyte composite layer is processed by melt-infiltrating Li into a porous electrolyte layer to increase Li/electrolyte interfacial area, see FIG. 11. As shown the pores that allow for the infiltration are uniform and in the same direction. This reduces interfacial resistance and increases critical current density. The electrolyte in the composite layer may be a composite itself, composed of a mixture of LLZO and selected Li₂O—P₂O₅—SiO₂—B₂O₃(LPSB, ˜2 g/cc) compounds to mitigate gravimetric energy density loss due to higher density of LLZO (5 g/cc) compared to Li (0.5 g/cc). Porous LLZO/LPSB composite electrolyte layers are produced by introducing selected sacrificial pore forming components e.g. corn or rice starch, or simple nm size organic polymer particles. Similar approaches have been taken on the cathode side of all-solid-state batteries by forming a catholyte, i.e. a cathode/electrolyte mixture or intermediate binary/ternary compound to reduce interfacial (charge transfer) resistance. Further embodiments comprise a composite electrolyte film with lithium infiltrated between the composite grains or as an intermediate electrolyte phase acting as an anolyte or a catholyte infiltrated in between the composite grains or the active material grains, e.g. in the cathode. Such intermediate electrolyte phase comprises at least two components resulting from the reaction of the lithium or the cathode materials with the electrolyte forming a binary or tertiary intermediate phase.

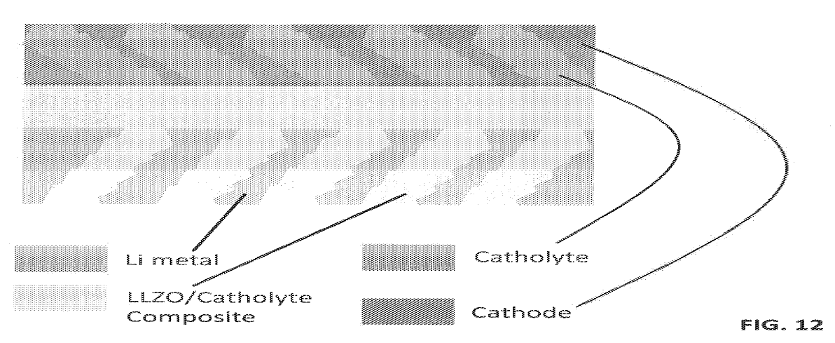

As discussed above, thin film LIBs have successfully cycled at practical levels. However, the cathode layer is only several μm thick, limiting the attainable energy density. For bulk battery systems, thicker (several tens μm) cathode layers are required. The present invention comprehends cathode/electrolyte or anode/electrolyte composite layers formed by infiltrating cathode or anode active materials into the solid-state electrolyte scaffolds to maximize the utilization of the active materials (cathode and anode) and to accelerate the ionic conductance on charge/discharge. See FIG. 11 and FIG. 12 which show schematic figures of such structures and the arrows are to show possible lithium ion conduction paths enabling faster rates of charge and discharge. The pore structure and uniformity of size and direction promote these composite structures and the batteries according to the present disclosure. The concept has been empirically proven in recent studies where LiCoO₂/LLZO and LiCoO₂/Li₃BO₃ composite cathode layers were bonded onto sintered LLZO pellets by deposition methods. However these pellets have random non-uniform pores and very low conductivity.

LLZO readily reacts with common cathode materials such as LiCoO₂, LiMn₂O₄, LiCoPO₄ at temperatures as low as 500-700° C. Resulting tertiary phases are often passive, exacerbating the battery performance. LLZO seems unlikely to serve as the catholyte, based on recent reports.

Binary or ternary compounds in the Li₂O—P₂O₅—SiO₂—B₂O₃(“LPSB”) system with moderate ionic conductivities (up to 3-4×10⁻³ mS cm⁻¹, composition selective) and thermodynamic compatibility with LLZO and cathode materials are utilized to form LPSB/LLZO and LPSB/cathode composites. Bonding of the two layers will reduce LLZO/cathode contact area and increase “active” contact of cathode and electrolyte. Benefits of this approach are shown in FIGS. 8A-8B and 9. In FIG. 8B we show a schematic of a Nickel-Manganese-Cobalt (NMC) cathode with an LLZO/polyaniline electrolyte scaffold. The polymer function is both mechanical for flexibility and electrical for conductivity. The electrically conductive polymer can be added directly to the nanoparticle slurry, preferably at a level of 20% by weight or less, more preferably 10% or less based on the total slurry weight. Other suitable electrically conductive polymers include but are not limited to: aromatic polymers such as polyfluorenes, polyphenylenes, polypyrenes, polyazulenes, polynaphthalenes, polyacetylenes (PACs), poly-p-phenylene vinylene (PPV); nitrogen containing aromatic polymers such as polypyrroles (PPYs), polycarbazoles, polyindoles, polyazepines and polyanilines (PANI); sulfur containing aromatic polymers such as poly-thiophenes (PTs), poly(3,4-ethylene-di-oxy-thiphene) (PDOT), and poly-p-phenylene sulfide (PPS). The preferred electrically conductive polymers for use are the polyanilines (PANI) as they have shown practical properties when applied in electrode form.

Among other features, the present invention comprehends: purchasing from commercial suppliers nanoparticles of c-LLZO or other solid-state electrolytes and Li(NxMyCz)O₂ cathode materials, with x+y+z=1, x:y:z=4:3:3 (NMC433), 5:3:2 (NMC532), 6:2:2 (NMC622), and 8:1:1 (NMC811) cathode NPs or using one of the described high-throughput methods to synthesizing these NPs materials at rates higher than 100 g/h.

Fabricating several tens cm² c-LLZO/LSPO composite films <10 μm thick, with conductivities of 0.5-1 mS/cm using any of the manufacturing methods shown in FIGS. 4A to 4D.

Fabricating several tens cm² Li(NxMyCz)O₂/LSPO wherein x+y+z=1 composite films 20-40 μm thick using any of the manufacturing methods shown in FIGS. 4A to 4D.

Fabricating several tens cm² bilayer c-LLZO/LSPO-LCO/LSPO films <60 μm thick using any of the manufacturing methods shown in FIGS. 4A to 4D.

In addition using polymer-derived interfacial coatings based on LiSiOₓ, LiPON and LiBOₓ for these fabricated layers.

Such all-solid-state LIBs as disclosed hereinabove eliminate thermal management systems and allow use of Li-metal anodes, providing batteries with higher volumetric/gravimetric energy densities, as well as the ability to safely operate at higher temperatures with faster charge/discharge rates that enable further flexibility in LIB designs.

Although an exemplary embodiment of the present invention has been described and illustrated, it will be apparent to those skilled in the art that numerous modifications and variations can be made thereto without departing from the scope of the invention as defined in the appended claims.

We claim:

1. An all solid-state Li-ion battery comprising a ceramic, solid-state electrolyte having a lithium-conducting oxide composition selected from the group consisting of perovskite-type oxides, NASICON-structured lithium electrolytes, and garnet-type structures containing transition metal oxides.

2. The solid-state Li-ion battery of claim 1, wherein the solid-state electrolyte is a c-LLZO.

3. The solid-state Li-ion battery of claim 1, wherein the solid-state electrolyte is mechanically flexible and can be wound in a jelly-roll configuration.

4. The solid-state Li-ion battery of claim 1, wherein the solid-state electrolyte is a c-LLZO-LSPO composite.

5. The solid-state Li-ion battery of claim 1, wherein an anode electrode comprises an anolyte compound surrounding an anode active material and enabling current densities above 1 mA/cm².

6. The solid-state Li-ion battery of claim 1, wherein a cathode electrode comprises a catholyte compound surrounding a cathode active material and enabling current densities above 1 mA/cm².

7. The solid-state battery of claim 1, wherein the solid-state electrolyte comprises an intermediate secondary phase surrounding a primary solid-state electrolyte material phase enabling ionic conductivities of 10⁻³ S cm⁻¹ or higher.

8. The solid-state Li-ion battery of any preceding claim, wherein the solid-state electrolyte is formed by liquid-feed flame spray pyrolysis and casting-sintering, wherein the sintering takes place at temperatures below approximately 1,100° C.

9. The solid-state Li-ion battery of any preceding claim, wherein the solid-state electrolyte is formed by casting-sintering a nanoparticle based slurry, wherein the sintering takes place at temperatures below approximately 1,100° C.

10. The solid-state Li-ion battery of any preceding claim, wherein the solid-state electrolyte has a low surface asperity, with an average roughness parameter of less than 400 nm, when the sintering takes place at temperatures below approximately 1,100° C. and a film thicknesses below 25 mm.

11. The solid-state Li-ion battery of any preceding claim, wherein the solid-state electrolyte has a low surface asperity, when the sintering takes place at temperatures below approximately 1,100° C. and a film thicknesses between 25 mm and 100 mm.

12. The solid-state Li-ion battery of any preceding claim, wherein the solid-state electrolyte, the anode, and/or the cathode include a LiPON coating applied pre-sintering or post-sintering.

13. The solid-state Li-ion battery of claim 5 or claim 6, wherein any of the solid-state electrolyte precursor nanoparticles or the sintered film, the cathode precursor nanoparticles or the sintered film, and the anode precursor nanoparticles or the sintered film are infiltrated with or pre-coated with, respectively, an intermediate phase between the electrolyte and a secondary or tertiary compound, a catholyte, or an anolyte selected from the group consisting of Li, Li₂O, B₂O₃, WO₃, SiO₂, Li₃PO₄, P₂O₅, Fe₃(PO₄)₂, Co₃(PO₄)₂, Ni₃(PO₄)₂, Mn₃(PO₄)₂, lithium phosphorous oxy-nitride (“LiPON”), LaTiO₃ and mixtures thereof.

14. The solid-state Li-ion battery of claim 1, wherein the NASICON-structured lithium electrolytes comprise LiM₂(PO₄)₃, where M=Ti, Zr, or Ge.

15. The solid-state Li-ion battery of claim 1, wherein the garnet-type structures containing transition metal oxides comprise Li₅La₃M₂O₁₂, where M is a transition metal.

16. The solid-state Li-ion battery of claim 1, wherein the solid-state electrolyte is a metal substituted c-LLZO with a general formula of Li₇La₍₃₋ₓ₎MₓZr₂O₁₂, wherein the metal M is selected from the group consisting of Al, Ga, Ta, W, and elements in group III and IV of the periodic table.

17. The solid-state Li-ion battery of claim 1, wherein the solid-state electrolyte is a metal substituted c-LLZO with a general formula of Li₇La₃Zr₍₂₋ₓ₎MₓO₁₂, wherein the metal M is selected from the group consisting of Sc, Y, Ti, and a transition metal.

18. The solid-state Li-ion battery of claim 1, wherein the garnet-type structures containing transition metal oxides comprise amorphous LiPON or LiSi—CON.

19. The solid-state Li-ion battery of claim 1, wherein the garnet-type structures containing transition metal oxides comprise lithium ion-conducting sulfides selected from the group consisting of Li₂S—P₂S₅ glass Li₂S—P₂S₅—Li₄SiO₄ glass, Li₂S—SiS₂ glass, Li₂S—Ga₂S₃—GeS₂ glass, Li₂S—Sb₂S₃—GeS₂ glass, Li₂S—GeS₂—P₂S₅ glass, Li₁₀GeP₂S₁₂ glass, Li₁₀SnP₂S₁₂ glass, Li₂S—SnS₂—As₂S₅ glass, and Li₂S—SnS₂—As₂S₅ glass-ceramic.

20. The solid-state Li-ion battery of any preceding claim, wherein Li is melt-infiltrated into the solid-state electrolyte, the anode or the cathode.

21. The solid-state Li-ion battery of any preceding claim, wherein the volumetric energy density is between 750 Wh/L and 1,200 Wh/L.

22. The solid-state Li-ion battery of any preceding claim, wherein the gravimetric energy density is between 350 Wh/kg and 650 Wh/kg.
